(19) United States
(12) Patent Application Publication
(10) Pub. No.: US 2018/0285922 A1
(43) Pub. Date: Oct. 4, 2018

(54) SUGGESTING CATEGORY CHANGES TO CAMPAIGNS

(71) Applicant: Google Inc., Mountain View, CA (US)

(72) Inventors: Justin Lewis, Marina del Rey, CA (US); Gavin James, Los Angeles, CA (US)

(21) Appl. No.: 14/331,383

(22) Filed: Jul. 15, 2014

(51) Int. Cl. G06Q 30/02

(52) U.S. Cl. CPC G06Q 30/0244; G06Q 30/0243

(57) ABSTRACT

Methods, systems, and apparatus include computer programs encoded on a computer-readable storage medium, including a method for updating campaigns. A first entity is identified with a first campaign, including selection criteria for delivery of content associated with the first campaign. At least one comparable second entity is identified, each having a respective campaign including selection criteria for delivery of content associated with the respective campaign. Categories are determined for the first campaign and respective campaigns of the comparable second entities. The determining is based on the selection criteria of a given campaign. Categories determined for the first entity are compared to the categories determined for the comparable second entities, including identifying missing categories not included in the first campaign but included in one or more campaigns of the comparable second entities. The missing categories are used to suggest a change to or adjust a portion of the first campaign.

### BACKGROUND

This specification relates to information presentation.

The Internet provides access to a wide variety of resources. For example, video and/or audio files, as well as webpages for particular subjects or particular news articles, are accessible over the Internet. Access to these resources presents opportunities for other content (e.g., advertisements) to be provided with the resources. For example, a webpage can include slots in which content can be presented. These slots can be defined in the webpage or defined for presentation with a webpage, for example, along with search results. Content in these examples can be of various formats, while the devices that consume (e.g., present) the content can be equally varied in terms of their type and capabilities.

Content slots can be allocated to content sponsors as part of a reservation system, or in an auction. For example, content sponsors can provide bids specifying amounts that the sponsors are respectively willing to pay for presentation of their content. In turn, an auction can be run, and the slots can be allocated to sponsors according, among other things, to their bids and/or a likelihood that the user will interact with the content presented. Bids can be based, for example, on predicted future opportunities to present content based on content sponsor specified selection criteria.

### SUMMARY

In general, one innovative aspect of the subject matter described in this specification can be implemented in methods that include a computer-implemented method for updating campaigns. The method includes identifying a first entity, the first entity having a first campaign including one or more selection criteria for delivery of content associated with the first campaign. The method further includes identifying at least one comparable second entity, each comparable second entity having a respective campaign including one or more selection criteria for delivery of content associated with the respective campaign. The method further includes determining, by one or more processors, categories for the first campaign and categories for each of the respective campaigns of the comparable second entities, wherein the determining is based on the selection criteria of a given campaign. The method further includes comparing, by one or more processors, the categories determined for the first entity to the categories determined for the comparable second entities including identifying missing categories that are not included in the first campaign but are included in one or more campaigns of the comparable second entities. The method further includes using the missing categories to suggest a change to or adjust a portion of the first campaign.

These and other implementations can each optionally include one or more of the following features. The selection criteria can be keywords. Identifying at least one comparable second entity can include identifying an entity that has one or more similarities to the first entity, and wherein the similarities are selected from the group comprising size, vertical, campaign size, campaign budget, targeting demographic, geographic location, social media presence, market share percentage, and language. Identifying at least one comparable second entity can include identifying a competitor of the first entity. Identifying at least one comparable second entity can include identifying two or more comparable second entities, and identifying missing categories can include identifying missing categories that are in common with the two or more comparable entities. The one or more second comparable entities can be adjacent competitors. Identifying missing categories can further include ranking the missing categories, and using the missing categories to suggest a change to or adjust a portion of the first campaign can includes using one or more top ranked categories. Ranking can be based on a degree of commonality of a category among the at least one second comparable entities. Ranking can be based on a significance of a respective category, wherein the significance is measured in terms of one or more campaign attributes. Using the missing categories to suggest a change to or adjust a portion of the first campaign can include providing one or more missing categories to the first entity as a suggestion for addition to the first campaign. Providing can further include providing suggestions for selection criteria to be used in the first campaign based on one or more of the missing categories. Providing can further include providing reach or other campaign metric estimates along with the suggestions. Providing can further include includes providing competitor share information for a suggested category, the competitor share information being an indication of a share that a competitor has for queries in a suggested category.

In general, another innovative aspect of the subject matter described in this specification can be implemented in computer program products that include a computer program product tangibly embodied in a computer-readable storage device and comprising instructions. The instructions, when executed by one or more processors, cause the processor to: identify a first entity, the first entity having a first campaign including one or more selection criteria for delivery of content associated with the first campaign; identify at least one comparable second entity, each comparable second entity having a respective campaign including one or more selection criteria for delivery of content associated with the respective campaign; determine categories for the first campaign and categories for each of the respective campaigns of the comparable second entities, wherein the determining is based on the selection criteria of a given campaign; compare the categories determined for the first entity to the categories determined for the comparable second entities including identifying missing categories that are not included in the first campaign but are included in one or more campaigns of the comparable second entities; and use the missing categories to suggest a change to or adjust a portion of the first campaign.

These and other implementations can each optionally include one or more of the following features. The selection criteria can be keywords. Identifying at least one comparable second entity can include identifying an entity that has one or more similarities to the first entity, and wherein the similarities are selected from the group comprising size, vertical, campaign size, campaign budget, targeting demographic, geographic location, social media presence, market share percentage, and language. Identifying at least one comparable second entity can include identifying two or more comparable second entities, and identifying missing categories can include identifying missing categories that are in common with the two or more comparable entities.

In general, another innovative aspect of the subject matter described in this specification can be implemented in systems, including a system comprising one or more processors and one or more memory elements including instructions. The instructions, when executed, cause the one or more processors to: identify a first entity, the first entity having a first campaign including one or more selection criteria for delivery of content associated with the first campaign; identify at least one comparable second entity, each comparable second entity having a respective campaign including one or more selection criteria for delivery of content associated with the respective campaign; determine categories for the first campaign and categories for each of the respective campaigns of the comparable second entities, wherein the determining is based on the selection criteria of a given campaign; compare the categories determined for the first entity to the categories determined for the comparable second entities including identifying missing categories that are not included in the first campaign but are included in one or more campaigns of the comparable second entities; and use the missing categories to suggest a change to or adjust a portion of the first campaign.

These and other implementations can each optionally include one or more of the following features. Identifying at least one comparable second entity can include identifying an entity that has one or more similarities to the first entity, and wherein the similarities are selected from the group comprising size, vertical, campaign size, campaign budget, targeting demographic, geographic location, social media presence, market share percentage, and language. Identifying at least one comparable second entity can include identifying two or more comparable second entities, and identifying missing categories can include identifying missing categories that are in common with the two or more comparable entities.

Particular implementations may realize none, one or more of the following advantages. Adjacent competitor-driven categorical recommendations can be used as a mechanism for generating impressions and traffic source suggestions for content sponsors (e.g., advertisers) to reach new markets and potentially additional customers. A tool can be provided that enables content sponsors to discover new categories for their campaigns. Content sponsors can be provided with suggestions for categories that are similar to categories in which the content sponsors already have presence, but may be lacking visibility.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for campaign suggestions.

FIG. 2 shows an example system for making suggestions for changing a campaign of a first entity using categories present in campaigns of comparable second entities.

FIG. 3 is a flowchart of an example process for providing campaign suggestions based on categories used in campaigns for comparable entities.

FIG. 4 is a block diagram of an example computer system that can be used to implement the methods, systems and processes described in this disclosure.

Like reference numbers and designations in the various drawings indicate like elements.

### DETAILED DESCRIPTION

Systems, methods, and computer program products are described for making suggestions for changing, creating, or otherwise facilitating a campaign of a first entity (e.g., a content sponsor) using categories that are present in the campaigns of comparable second entities. For example, the categories may be missing from the first entity's campaign, e.g., as determined from an evaluation of keywords that are included in the campaign's selection criteria as compared to categories associated with campaigns of other entities. For a given entity, for example, one or more comparable second entities can be identified. The categories (e.g., based on keywords) of the comparable second entities' campaigns can be compared to the categories of the first entity's campaign. If any categories are missing from the first entity's campaign, for example, then the missing categories can be used to generate suggestions for presentation to the first entity. For example, suggestions can be presented to the content sponsor associated with the first entity's campaign, e.g., in a user interface for maintaining campaigns. In some implementations, the suggested categories (or other identified suggestions) can be limited to categories (or keywords) that may have significant performance metrics for the comparable second entities. Other ways can be used to identify and suggest campaign changes for an entity based on campaign selection criteria or information for comparable second entities.

Content sponsor (e.g., entity, advertiser) information that is specific to a particular content sponsor is kept private or is obfuscated, e.g., to avoid providing a particular advertiser's information to its competitors. For example, information from an individual comparable second entity is not shared or made public, the names of comparable second entities are not provided, and comparison information that is used is anonymized and/or aggregated. Other ways of protecting specific content sponsor information and privacy are possible.

For situations in which the systems discussed here collect and/or use personal information about users, the users may be provided with an opportunity to enable/disable or control programs or features that may collect and/or use personal information (e.g., information about a user's social network, social actions or activities, a user's preferences or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

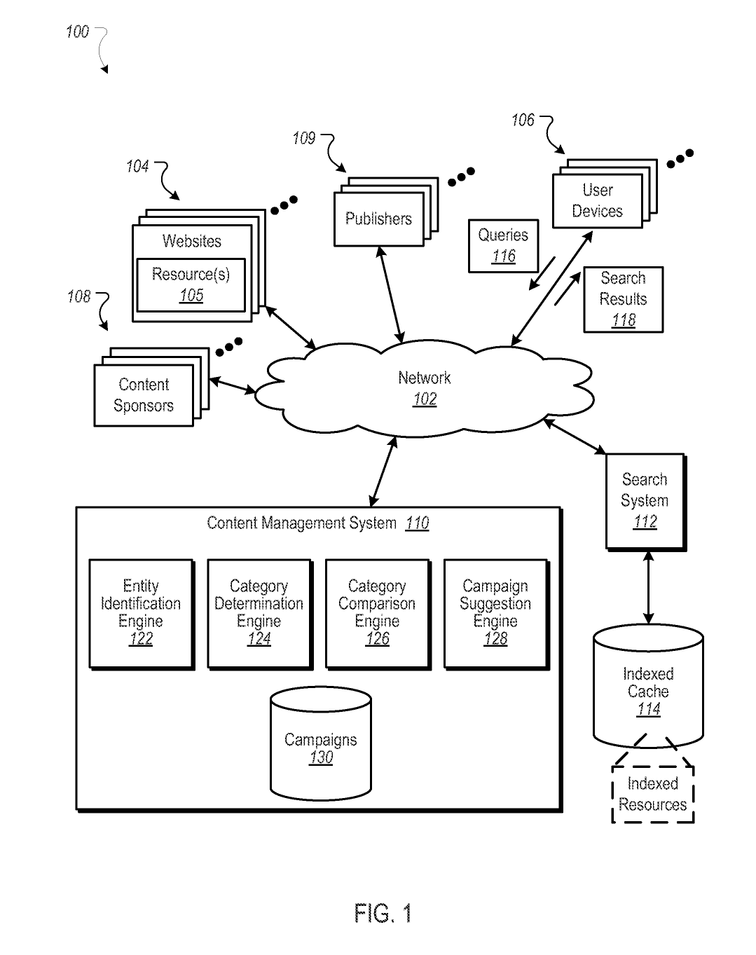

FIG. 1 is a block diagram of an example environment 100 for providing campaign suggestions. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104, user devices 106, content sponsors 108 (e.g., advertisers), publishers 109, and the content management system 110. The example environment 100 may include many thousands of websites 104, user devices 106, content sponsors 108 and publishers 109.

The environment 100 can include plural data stores, which can be stored locally by the content management system 110, stored somewhere else and accessible using the network 102, generated as needed from various data sources, or some combination of these. Further, some data stores described herein may include identifiers that can be used to match or access corresponding data records or other information that are stored elsewhere, e.g. locally and/or remotely.

A data store of campaigns 130, for example, can include campaigns (e.g., content item campaigns) that are associated with an entity, such as a particular content sponsor 108 (e.g., an advertiser). Each campaign 130 can include campaign parameters, e.g., including keywords that are used for selecting content items (e.g., advertisements) for presentation to users in response to a request for content that includes keywords in the selection criteria.

The content management system 110 can include plural engines, some or all of which may be combined or separate, and may be co-located or distributed (e.g., connected over the network 102). An entity identification engine 122, for example, can identify a first entity for which campaign suggestions based on categories are to be generated. The entity identification engine 122 can also identify at least one comparable second entity having one or more respective campaigns, including one or more selection criteria for delivery of content associated with the respective campaigns. Comparable second entities that are identified can include, for example, entities that have campaigns having commonalities with a campaign of the first entity. Commonalities can include, for example, one or more categories in common, common keywords, similar products and/or services, markets or verticals, common customers or audience base, similar demographics, similar locations, similar customer interests, similar past sales, similar user/customer browsing history, and/or other common attributes or signals. First entities that are identified for the purpose of generating suggestions can include, e.g., a content sponsor currently using a content sponsor interface to maintain a campaign, or a group of entities for which suggested categories or related suggestions are to be generated in a batch or other group for subsequent presentation.

A category determination engine 124, for example, can determine categories for a respective campaign. The categories that are determined, for example, can include categories that are selected based on the selection criteria (e.g., associated keywords) of a particular campaign. In some implementations, categories that are determined can be determined directly from lists of categories that are stored with particular ones of the campaigns 130 or from lists of categories that are indexed by keyword.

A category comparison engine 126, for example, can compare a set of categories associated with a first entity's campaign with a set of categories determined for comparable second entities (e.g., identified by the category determination engine 124). The comparison, for example, can include identifying a set of missing categories. The missing categories can include categories, for example, that are not included in the campaign associated with the first entity but are included in one or more campaigns of the comparable second entities. In some implementations, comparing can include identifying one or more additional categories of the first entity that are not included in the campaigns associated with the comparable second entities.

A campaign suggestion engine 128, for example, can use a set of missing categories (e.g., identified by the category comparison) to suggest a change to an entire campaign or an adjustment to a portion of a first campaign. For example, the campaign suggestion engine 128 can create a set of campaign suggestions that can be provided to a user device for presentation to a first entity (e.g., a content sponsor). The suggestions can include, for example, suggestions of specific categories and/or keywords associated with one or more of the specific categories that the first entity may want to use to update the corresponding campaign.

A website 104 includes one or more resources 105 associated with a domain name and hosted by one or more servers. An example website is a collection of webpages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript™ scripts).

A user device 106 is an electronic device that is under control of a user and is capable of requesting and receiving resources over the network 102. Example user devices 106 include personal computers (PCs), televisions with one or more processors embedded therein or coupled thereto, set-top boxes, gaming consoles, mobile communication devices (e.g., smartphones), tablet computers and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or webpage, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 can, for example, access the indexed cache 114 to identify resources that are relevant to the search query 116. The search system 112 identifies the resources in the form of search results 118 and returns the search results 118 to the user devices 106 in search results pages. A search result 118 can be data generated by the search system 112 that identifies a resource that is provided in response to a particular search query, and includes a link to the resource. Search results pages can also include one or more slots in which other content items (e.g., advertisements) can be presented.

When a resource 105, search results 118 and/or other content (e.g., a video) are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110 in association with a given request. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116. In addition, when no search is performed or no keywords are available (e.g., because the user is not browsing a webpage), other information, such as information obtained from one or more snapshots, can be used to respond to the received request. In some implementations, the selection of the eligible content items can further depend on user signals, such as demographic signals, behavioral signals or other signals derived from a user profile.

The content management system 110 can select from the eligible content items that are to be provided for presentation in slots of a resource or search results page based at least in part on results of an auction (or by some other selection process). For example, for the eligible content items, the content management system 110 can receive offers from content sponsors 108 and allocate the slots, based at least in part on the received offers (e.g., based on the highest bidders at the conclusion of the auction or based on other criteria, such as those related to satisfying open reservations and a value of learning). The offers represent the amounts that the content sponsors are willing to pay for presentation of (or selection of or other interaction with) their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay (e.g., a cost per engagement) for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, a value of learning, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a webpage, and consummates a purchase there before leaving that webpage. A conversion can also be defined by a content provider to be any measurable or observable user action, such as downloading a white paper, navigating to at least a given depth of a website, viewing at least a certain number of webpages, spending at least a predetermined amount of time on a web site or webpage, registering on a website, experiencing media, or performing a social action regarding a content item (e.g., an ad), such as endorsing, republishing or sharing the content item. Other actions that constitute a conversion can also be used.

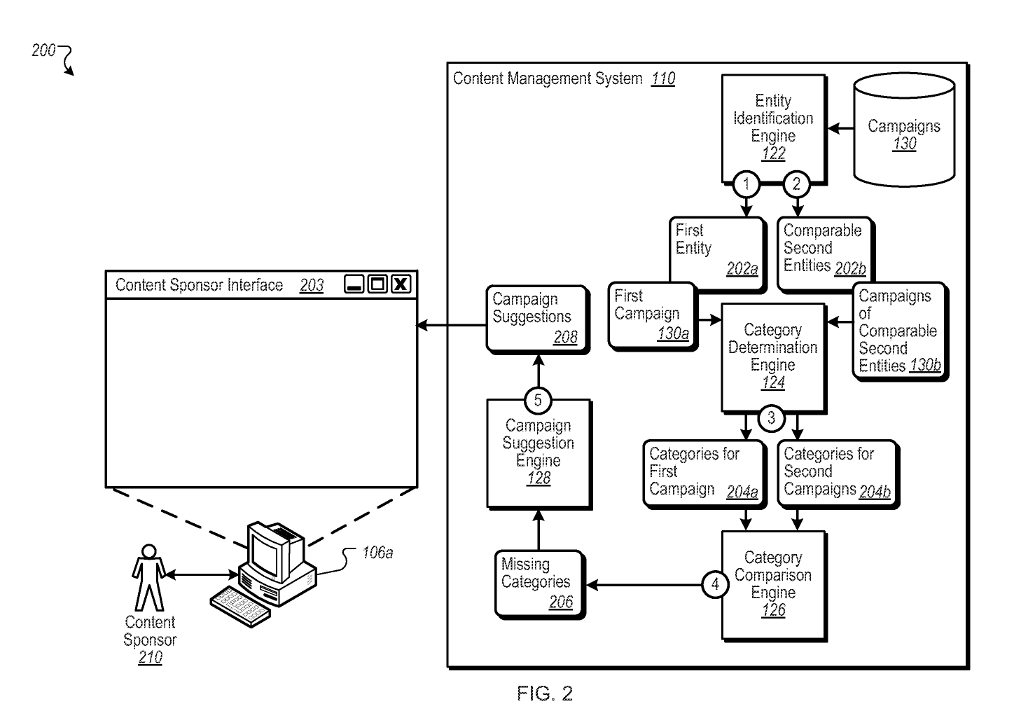

FIG. 2 shows an example system 200 for making suggestions for changing a campaign of a first entity using categories present in campaigns of comparable second entities. For example, for a given first entity 202a, the content management system 110 can identify comparable second entities 202b. Categories 204a can be identified for a first campaign 130a of the first entity 202a. Categories 204b can be identified for campaigns 130b of the comparable second entities 202b. By comparing the categories 204a and 204b, for example, missing categories 206 (or additional categories) can be identified that include categories that are present in the categories 204b but missing (or included) from the categories 204a. Using the missing categories 206 (or additional categories), for example, the content management system 110 can generate campaign suggestions 208. The campaign suggestions 208 can include, for example, suggested changes that can be made to the first campaign 130a in order to reach additional users (e.g., potential customers) and markets not currently being reached by the first campaign 130a. In some implementations, the campaign suggestions 208 can be used for presentation to a content sponsor 210 (e.g., the first entity 202a), using a content sponsor interface 203 for maintaining campaigns. In some implementations, the following example stages can be used for generating suggestions for updating campaigns.

At stage 1, for example, the entity identification engine 122 can identify a first entity 202a, the first entity 202a having the first campaign 130a including one or more selection criteria for delivery of content associated with the first campaign 130a. For example, the first entity 202a can be a content sponsor (e.g., Advertiser A) associated with Example Brand Shoes. Advertiser A may have several campaigns 130 that can include, for example, various advertisement creatives for Example Brand shoes. One of the campaigns 130, for example, can be the first campaign 130a that is an advertising campaign for a particular style of walking shoes manufactured by Example Brand Shoes. Identification of the first entity 202a (e.g., Advertiser A) can occur, for example, when Advertiser A is using a content sponsor interface for creating or updating advertisement creatives. The first entity 202a can be identified based on performance of a given campaign, or lack thereof, such as for campaign 130a. In some implementations, the first entity is identified in response to a query by the first entity to optimize a campaign. Other methods for identifying the first entity 202a are possible.

At stage 2, for example, the entity identification engine 122 can identify at least one comparable second entity 202b, each comparable second entity 202b having a respective campaign. As an example, the comparable second entity 202b can be at least one other advertiser (e.g., Advertiser B, products for fit seniors) who has associated campaigns 130b of the comparable second entities 202b. Each campaign 130b can include one or more selection criteria for delivery of content associated with the respective campaign. The comparable second entities 202b identified by the entity identification engine 122 can include, for example, other shoe advertisers and/or advertisers of products or services that are likely to have customers in common with (or have potential interest by) customers of Example Brand Shoes. For example, commonality can be determined by demographics, location, customer interests, past sales, user browsing history, or other signals. As such, the comparable second entities 202b identified by the entity identification engine 122 in this example for Example Brand shoes can also include clothing manufacturers, fitness-related entities, and/or sports-related entities. One or more comparable second entities 202b can be identified, each having one or more campaigns 130b of the comparable second entities 202b. In some implementations, the comparable second entities 202b that are identified can include entities having campaigns that have at least one category in common with the first entity 202a, or entities that have a similar audience base.

At stage 3, for example, the category determination engine 124 can determine categories 204a for the first campaign 130a and categories 204b for each of the respective campaigns of the comparable second entities 202b, wherein the determining is based on the selection criteria of a given campaign. The categories 204a determined for the first campaign 130a, for example, can include Sports, Fitness, Shoes and other categories that Advertiser A has considered for campaigns, e.g., when selecting categories and associated keywords for advertisement creatives. The categories 204b determined for the one or more campaigns 130b of the comparable second entities 202b (e.g., including Advertiser B, having products for fit seniors), for example, can include the same or different categories. For example, the categories 204b can include categories of Retirement, Apparel & Accessories, Senior Activities, and/or other categories that Advertiser B has considered for campaigns (e.g., including Sports, Fitness and Shoes). There can be other categories 204b determined in this stage, such as for other campaigns 130b of the comparable second entities 202b associated with other comparable second entities 202b (e.g., in addition to Advertiser B).

In some implementations, categories 204a and categories 204b can be determined from the keywords used in the respective campaigns. For example, the keywords that are used can include specific keywords that are known to drive impressions, interactions, conversions and/or clicks for associated advertisements. The specific keywords can then be used to identify the categories. In some implementations, categories identified in stage 3 can be limited to categories for which each particular content sponsor spends a predetermined amount of $S per period (e.g., per month) or at least P % (e.g., at least 5%) of the content sponsor's advertising budget. Other ways can be used for limiting the categories that are determined.

At stage 4, for example, the category comparison engine 126 can compare the categories 204a determined for the first entity 202a to the categories 204b determined for the comparable second entities 202b. Category identification can include identifying missing categories 206 that are not included in the first campaign 130a but are included in one or more campaigns 130b of the comparable second entities 202b. For example, the category comparison engine 126 can determine that the missing categories 206 (e.g., missing from the first campaign 130a, Advertiser A's campaign for Example Brand Shoes) include Retirement, Apparel & Accessories and Senior Activities.

At stage 5, for example, the campaign suggestion engine 128 can use the missing categories 206 to suggest a change to (or adjust a portion of) the first campaign 130a. For example, the campaign suggestion engine 128 can create campaign suggestions 208 that can be provided to the user device 106a for presentation to the content sponsor 210 (e.g., Advertiser A). The campaign suggestions 208 can include suggestions, e.g., along the lines of “Your competitors are advertising to the categories of Retirement, Apparel & Accessories and Senior Activities, so you may want to consider using these categories in your campaigns.” In another example, the campaign suggestions 208 can include keyword suggestions, e.g., along the lines of “To present your ads to customers interested in the categories of Retirement, Apparel & Accessories and Senior Activities, try adding these keywords . . . .” In some implementations, suggestions can be presented in tabular or list form that allows the content sponsor to use controls (e.g., checkboxes) to easily add missing categories (and/or associated keywords) and remove extraneous categories (and/or associated keywords). In some implementations, some campaigns can be set up by campaign sponsors to be updated automatically using suggested categories (e.g., on a trial basis for subsequent permanent inclusion by the content sponsor).

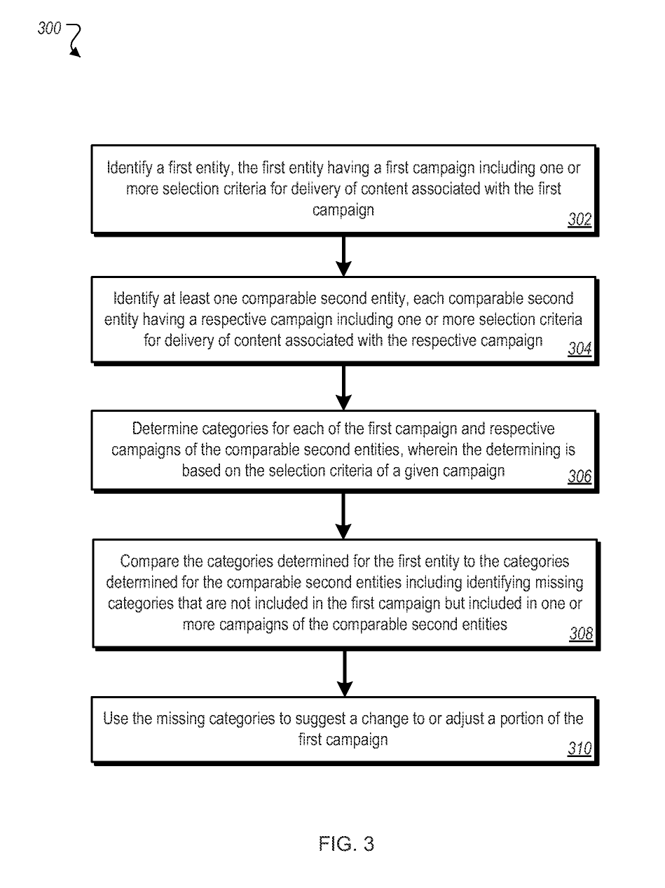

FIG. 3 is a flowchart of an example process 300 for providing campaign suggestions based on categories used in campaigns for comparable entities. In some implementations, the content management system 110 can perform steps of the process 300 using instructions that are executed by one or more processors. FIGS. 1-2 are used to provide example structures for performing the steps of the process 300.

A first entity is identified, the first entity having a first campaign including one or more selection criteria for delivery of content associated with the first campaign (302). As an example, the entity identification engine 122 can identify the first entity 202a (e.g., Advertiser A) associated with Example Brand Shoes that has the first campaign 130a. The first campaign 130a, for example, can be an advertising campaign for a particular style of walking shoes manufactured by Example Brand Shoes.

At least one comparable second entity is identified, each comparable second entity having a respective campaign including one or more selection criteria for delivery of content associated with the respective campaign (304). The entity identification engine 122, for example, can identify one or more comparable second entities 202b, each being associated with one or more of the campaigns 130b of the comparable second entities 202b. One of the comparable second entities 202b can be, for example, the Advertiser B that advertises its products to fitness-minded seniors. Advertiser B may be selected as one of the comparable second entities 202b, for example, because products/services associated with Advertiser B have customers in common with (or have potential interest by) customers of Example Brand Shoes, e.g., determined by demographics, location, customer interests, past sales, user browsing history, or other signals.

In some implementations, the one or more comparable second entities can be adjacent competitors. For example, one or more comparable second entities 202b identified by the entity identification engine 122 can be a competitor of Advertiser A's, e.g., in the line of shoes.

In some implementations, the selection criteria can be keywords. For example, the selection criteria used by the entity identification engine 122 for identifying comparable entities can be keywords that are included in the campaigns 130b of the comparable second entities 202b, e.g., that match keywords of the first campaign 103a of the first entity 202a. In some implementations, other selection criteria can be used in the identifying, such as non-keyword selection criteria (e.g., location).

In some implementations, identifying at least one comparable second entity can include identifying an entity that has one or more similarities to the first entity. For example, in determining comparable second entities 202b, the entity identification engine 122 can look for similarities between the entities that include one or more of entity size, vertical, campaign size, campaign budget, demographic, geographic location, social media presence, market share percentage, and language.

In some implementations, identifying at least one comparable second entity can include identifying a competitor of the first entity. The entity identification engine 122, for example, can identify comparable second entities 202b that are direct competitors of the first entity 202a, e.g., based on products/service, market share and/or other factors associated with the entities.

In some implementations, identifying at least one comparable second entity can include identifying two or more comparable second entities, and identifying missing categories can include identifying missing categories that are in common with the two or more comparable entities. For example, the entity identification engine 122 can use a threshold of two (or some other number) as a minimum number of comparable second entities 202b that have a particular missing category 206 (e.g., missing from the first campaign 130a) before giving a suggestion of such a category to an identified entity. If a particular category is missing from the first campaign 130a, for example, but only present in the campaigns 130b of a single comparable second entity 202b, then the particular category can be omitted from the missing categories 206 (e.g., not considered a strong enough category to be used in generating suggestions). Other ways can be used to limit the missing categories 206 to categories that may be more likely to be beneficial to the first entity 202a.

Categories are determined for each of the first campaign and respective campaigns of the comparable second entities, wherein the determining is based on the selection criteria of a given campaign (306). As an example, the category determination engine 124 can determine the categories 204a for the first campaign 130a and the categories 204b for each of the respective campaigns 130b of the comparable second entities 202b. Determining the categories can be based, for example, on the selection criteria of a given campaign, including keywords identified as selection criteria for each campaign. The categories 204a determined for the first campaign 130a, for example, can include Sports, Fitness, Shoes and other categories that Advertiser A has considered for campaigns. The categories 204b determined for the one or more campaigns 130b of the comparable second entities 202b (e.g., including Advertiser B, having products for fit seniors), for example, can include the same or different categories. The categories 204b can include, for example, categories of Retirement, Apparel & Accessories, Senior Activities, and/or other categories that Advertiser B has considered for campaigns (e.g., including Sports, Fitness and Shoes).

The categories determined for the first entity are compared to the categories determined for the comparable second entities, including identifying missing (or additional) categories that are not included in the first campaign but included in one or more campaigns of the comparable second entities (308). The category comparison engine 126, for example, can compare the categories 204a determined for the first entity 202a to the categories 204b determined for the comparable second entities 202b. Comparing can include, for example, identifying missing categories 206 that are not included in the first campaign 130a but are included in one or more campaigns 130b of the comparable second entities 202b. As such, the missing categories 206 can include Retirement, Apparel & Accessories and Senior Activities.

The missing categories are used to suggest a change to or adjust a portion of the first campaign (310). For example, the campaign suggestion engine 128 can use the missing categories 206 to create the campaign suggestions 208 that are associated with the first campaign 130a, as described above. For example, the campaign suggestions 208 can include suggestions to Advertiser A for changing or adjusting a portion of the first campaign 130a. The campaign suggestions 208 can include suggestions, for example, to use additional categories and/or keywords for the selection of content in the campaign for Example Brand Shoes.

In some implementations, identifying missing categories can further include ranking the missing categories, and using the missing categories to suggest a change to or adjust a portion of the first campaign can include using/suggesting one or more top-ranked categories. For example, the campaign suggestion engine 128 can rank the missing categories 206 in various ways and use the highest-ranked missing categories 206 to generate the campaign suggestions 208. In some implementations, ranking can be based on a degree of commonality of a category among the at least one comparable second entity. For example, a missing category 206 that is shared among several of the comparable second entities 202b can be ranked higher than a missing category 206 that is shared among fewer ones of the comparable second entities 202b. In some implementations, ranking can be based on a significance of a respective category, wherein the significance is measured in terms of one or more campaign attributes. As an example, the campaign suggestion engine 128 can rank particular ones of the missing categories 206 higher, e.g., based on a market share percentage that is attributable to the category or some other attribute.

In some implementations, using the missing categories to suggest a change to or adjust a portion of the first campaign can include providing one or more missing categories to the first entity as a suggestion for addition to the first campaign. The campaign suggestion engine 128, for example, can include the name of specific ones of the missing categories 206, e.g., instead of (or in addition to) suggesting specific keywords associated with the categories and/or other campaign suggestions 208.

In some implementations, providing one or more missing categories can further include providing suggestions for selection criteria to be used in the first campaign based on one or more of the missing categories. For example, the campaign suggestions 208 can include specific suggestions that the content management system 110 provides to the user device 106a for presentation to the content sponsor 210 for making changes to the first campaign 130a.

In some implementations, providing one or more missing categories can further include providing reach or other campaign metric estimates along with the suggestions. For example, the campaign suggestions 208 can include metrics associated with campaigns of one or more comparable second entities 202b whose campaigns use the categories/keywords that are included or identified in the campaign suggestions 208. The metrics can include for each category/keyword, for example, information including N impressions, M opportunities, and/or other metrics.

In some implementations, providing one or more missing categories can further include providing competitor share information for a suggested category, the competitor share information being an indication of a share that a competitor has for queries in a suggested category. For example, the campaign suggestions 208 can include information along the line of “Competitor X, using this category, receives 14% of the queries related to walking shoes used by seniors to walk in malls.” Other messages and/or competitor share information is possible.

In some implementations, suggestions can be based on performance metrics of the campaigns of the comparable second entities, including performance metrics that identify traffic sources that drive the performance. For example, analogous techniques can be used to determine where/how traffic is coming to a channel, (e.g., a video sharing website), and traffic-based information (e.g., including traffic comparisons) can be provided to a content sponsor. The traffic based information can include, for example, the amount of traffic on a channel basis, and the traffic based information can be used to compare the effectiveness of campaigns of competing content sponsors. For example, for a given content sponsor, traffic sources of the content sponsor's competitors can be identified, e.g., including traffic sources that are different from those of the content sponsor. For example, for a particular advertisement, traffic based information that is identified can include keyword categories, domain categories, topics used for content selection, subscription feeds (e.g., uploads, likes, curates, etc.), social media and dark sharing methods (e.g., chats, emails, messages). The traffic based information can be used, for example, to identify how the content sponsor is doing with respect to reaching their audience as compared to similar or competitor channels. Content sponsors can be provided, for example, with information along the lines of “Here are the categories that your competitors are using . . . .” In some implementations, information provided to content sponsors can include information along the lines of “Your competitors, using Category ‘X’, had N impressions in M opportunities.”

In some implementations, when traffic information is used and/or presented, some data can be obscured, e.g., including competing content sponsor information that should or is obligated be kept private. For example, instead of describing the exact keywords used by competitors and exact metrics associated with the keywords, content sponsors can be presented with market share information, e.g., segmented by keyword recommendation. In another example, metrics (and/or information included with suggestions) can be presented in a way that represents a percentage of the total impressions or interactions. Other techniques for obfuscating data that is shared can be used.

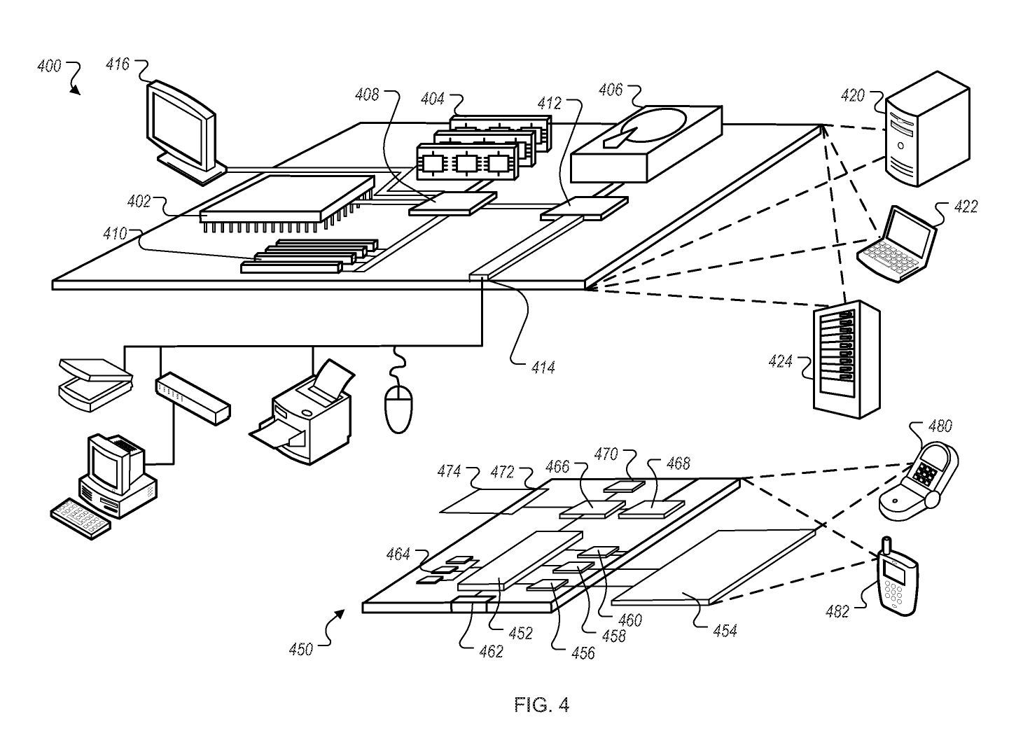

FIG. 4 is a block diagram of example computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 400 is further intended to represent any other typically non-mobile devices, such as televisions or other electronic devices with one or more processors embedded therein or attached thereto. Computing device 450 is intended to represent various forms of mobile devices, such as personal digital assistants, cellular telephones, smartphones, and other computing devices. The components shown here, their connections and relationships, and their functions, are meant to be examples only, and are not meant to limit implementations of the inventions described and/or claimed in this document.

Computing device 400 includes a processor 402, memory 404, a storage device 406, a high-speed controller 408 connecting to memory 404 and high-speed expansion ports 410, and a low-speed controller 412 connecting to low-speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high-speed controller 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low-speed controller 412 manages lower bandwidth-intensive operations. Such allocation of duties is an example only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed bus 414. The low-speed bus 414 (e.g., a low-speed expansion port), which may include various communication ports (e.g., USB, Bluetooth®, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as computing device 450. Each of such devices may contain one or more of computing devices 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The computing device 450 may also be provided with a storage device, such as a micro-drive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the computing device 450, such as control of user interfaces, applications run by computing device 450, and wireless communication by computing device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of computing device 450 with other devices. External interface 462 may provide, for example, for wired communication (e.g., via a docking procedure) or for wireless communication (e.g., via Bluetooth® or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to computing device 450 through expansion interface 472, which may include, for example, a subscriber identification module (SIM) card interface. Such expansion memory 474 may provide extra storage space for computing device 450, or may also store applications or other information for computing device 450. Specifically, expansion memory 474 may include instructions to carry out or supplement the processes described above, and may include secure information also. Thus, for example, expansion memory 474 may be provide as a security module for computing device 450, and may be programmed with instructions that permit secure use of computing device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Computing device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 468 (e.g., a radio-frequency transceiver). In addition, short-range communication may occur, such as using a Bluetooth®, WiFi, or other such transceiver (not shown). In addition, GPS receiver module 470 may provide additional wireless data to computing device 450, which may be used as appropriate by applications running on computing device 450.

Computing device 450 may also communicate audibly using audio codec 460, which may receive spoken information from a user and convert it to usable digital information. Audio codec 460 may likewise generate audible sound for a user, such as through a speaker, e.g., in a handset of computing device 450. Such sound may include sound from voice telephone calls, may include recorded sound (e.g., voice messages, music files, etc.) and may also include sound generated by applications operating on computing device 450.

The computing device 450 may be implemented in a number of different forms, as shown in the figure. For example, it may be implemented as a cellular telephone 480. It may also be implemented as part of a smartphone 482, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
identifying a first entity, the first entity having a first campaign including one or more selection criteria for delivery of content associated with the first campaign;
identifying at least one comparable second entity, each comparable second entity having a respective campaign including one or more selection criteria for delivery of content associated with the respective campaign;
determining, by one or more processors, categories for the first campaign and categories for each of the respective campaigns of the comparable second entities, wherein the determining is based on the selection criteria of a given campaign;
comparing, by the one or more processors, the categories determined for the first entity to the categories determined for the comparable second entities including identifying missing categories that are not included in the first campaign but are included in one or more campaigns of the comparable second entities;
determining, by the one or more processors, performance metrics of the one or more campaigns for the comparable second entities;
determining, by the one or more processors, for the first campaign, and based on the performance metrics, a set of campaign suggestions that includes at least one of the missing categories and a suggested keyword or string of keywords for the at least one missing category, including:
ranking the missing categories based on one or more of the performance metrics; and
including in the set of campaign suggestions, a particular missing category having a highest given performance metric from among the one or more of the performance metrics; and
using the set of campaign suggestions, the suggested keyword or string of keywords, and the performance metrics to suggest a change to or adjust a portion of the first campaign.

2. The method of claim 1 wherein the selection criteria are keywords.

3. The method of claim 1 wherein identifying at least one comparable second entity includes identifying an entity that has one or more similarities to the first entity, and wherein the similarities are selected from the group comprising size, vertical, campaign size, campaign budget, demographic, geographic location, social media presence, market share percentage, and language.

4. The method of claim 1 wherein identifying at least one comparable second entity includes identifying a competitor of the first entity.

5. The method of claim 1 wherein identifying at least one comparable second entity includes identifying two or more comparable second entities, and wherein identifying missing categories includes identifying missing categories that are in common with the two or more comparable entities.

6. The method of claim 1 wherein the one or more comparable second entities are adjacent competitors.

7. (canceled)

8. The method of claim 1, wherein the ranking is based on a degree of commonality of a category among the at least one comparable second entity.

9. The method of claim 1, wherein the ranking is based on a significance of a respective category, wherein the significance is measured in terms of one or more campaign attributes.

10-12. (canceled)

13. The method of claim 1 wherein the performance metrics include competitor share information for a suggested category, the competitor share information being an indication of a share that a competitor has for queries in a suggested category.

14. A computer program product embodied in a non-transitive computer-readable medium including instructions, that when executed, cause one or more processors to:
identify a first entity, the first entity having a first campaign including one or more selection criteria for delivery of content associated with the first campaign;
identify at least one comparable second entity, each comparable second entity having a respective campaign including one or more selection criteria for delivery of content associated with the respective campaign;
determine categories for the first campaign and categories for each of the respective campaigns of the comparable second entities, wherein the determining is based on the selection criteria of a given campaign;
compare the categories determined for the first entity to the categories determined for the comparable second entities including identifying missing categories that are not included in the first campaign but are included in one or more campaigns of the comparable second entities;
determine performance metrics of the one or more campaigns for the comparable second entities;
determine, for the first campaign, and based on the performance metrics, a set of campaign suggestions that includes at least one of the missing categories and a suggested keyword or string of keywords for the at least one missing category, including:
rank the missing categories based on one or more of the performance metrics; and
include in the set of campaign suggestions, a particular missing category having a highest given performance metric from among the one or more of the performance metrics; and
use the set of campaign suggestions, the suggested keyword or string of keywords, and the performance metrics to suggest a change to or adjust a portion of the first campaign.

15. The computer program product of claim 14 wherein the selection criteria are keywords.

16. The computer program product of claim 14 wherein identifying at least one comparable second entity includes identifying an entity that has one or more similarities to the first entity, and wherein the similarities are selected from the group comprising size, vertical, campaign size, campaign budget, demographic, geographic location, social media presence, market share percentage, and language.

17. The computer program product of claim 14 wherein identifying at least one comparable second entity includes identifying two or more comparable second entities, and wherein identifying missing categories includes identifying missing categories that are in common with the two or more comparable entities.

18. A system comprising:
one or more processors; and
one or more memory elements including instructions that, when executed, cause the one or more processors to:
identify a first entity, the first entity having a first campaign including one or more selection criteria for delivery of content associated with the first campaign;
identify at least one comparable second entity, each comparable second entity having a respective campaign including one or more selection criteria for delivery of content associated with the respective campaign;
determine categories for the first campaign and categories for each of the respective campaigns of the comparable second entities, wherein the determining is based on the selection criteria of a given campaign;
compare the categories determined for the first entity to the categories determined for the comparable second entities including identifying missing categories that are not included in the first campaign but are included in one or more campaigns of the comparable second entities;
determine performance metrics of the one or more campaigns for the comparable second entities;
determine, for the first campaign, and based on the performance metrics, a set of campaign suggestions that includes at least one of the missing categories and a suggested keyword or string of keywords for the at least one missing category, including:
rank the missing categories based on one or more of the performance metrics; and
include in the set of campaign suggestions, a particular missing category having a highest given performance metric from among the one or more of the performance metrics; and
use the set of campaign suggestions, the suggested keyword or string of keywords, and the performance metrics missing categories to suggest a change to or adjust a portion of the first campaign.

19. The system of claim 18 wherein identifying at least one comparable second entity includes identifying an entity that has one or more similarities to the first entity, and wherein the similarities are selected from the group comprising size, vertical, campaign size, campaign budget, demographic, geographic location, social media presence, market share percentage, and language.

20. The system of claim 18 wherein identifying at least one comparable second entity includes identifying two or more comparable second entities, and wherein identifying missing categories includes identifying missing categories that are in common with the two or more comparable entities.

21. The method of claim 1, wherein the performance metrics include traffic based information comprising the amount of traffic on a channel basis, wherein the traffic based information is used to compare the effectiveness of campaigns of the comparable second entities.

22. The computer program product of claim 14, wherein the performance metrics include competitor share information for a suggested category, the competitor share information being an indication of a share that a competitor has for queries in a suggested category.

23. The system of claim 18, wherein the performance metrics include traffic based information comprising the amount of traffic on a channel basis, wherein the traffic based information is used to compare the effectiveness of campaigns of the comparable second entities.

24. The system of claim 18, wherein the performance metrics include competitor share information for a suggested category, the competitor share information being an indication of a share that a competitor has for queries in a suggested category.
